(19) United States
(12) Patent Application Publication
(10) Pub. No.: US 2026/0276464 A1
(43) Pub. Date: Sep. 17, 2026

(54) SUB-COMPONENT SHEAR SENSOR

(71) Applicant: Honeywell Federal Manufacturing & Technologies, LLC, Kansas City, MO (US)

(72) Inventors: Daniel Benjamin Hartley, Holden, MO (US); Ryan John Eickbush, Lee’s Summit, MO (US)

(21) Appl. No.: 19/566,070

(22) Filed: Mar. 13, 2026

Related U.S. Application Data
(60) Provisional application No. 63/771,344, filed on Mar. 13, 2025.

(51) Int. Cl. G01L 5/00

(52) U.S. Cl. CPC G01L 5/00

(57) ABSTRACT

A practical component configured to be connected to a substrate and subjected to a washing process for determining a shear force and/or a shear direction under the practical component. The practical component comprising a body, a movable section, and a sensor. The body includes a bridge and a number of supports extending from the bridge such that the body forms a space thereunder. The supports are configured to be secured to the substrate for retaining the practical component in a fixed position relative to the substrate. The movable section is at least partially positioned in the space and configured to shift relative to the body from liquid passing through the space. The sensor is configured to detect movement of the movable section relative to the body and hence a shear force of the liquid against the movable section.

### RELATED APPLICATIONS

This regular utility non-provisional patent application claims priority benefit, with regard to all common subject matter, of earlier-filed U.S. Provisional Patent Application Serial No. 63/771,344, titled SUB-COMPONENT SHEAR SENSOR, filed Mar. 13, 2025. Application Serial No. 63/771,344 is hereby incorporated by reference in its entirety into the present patent application.

### GOVERNMENET INTERESTS

This invention was made with Government support under Contract No.: DE-NA-0002839 awarded by the United States Department of Energy/National Nuclear Security Administration. The Government has certain rights in the invention.

### BACKGROUND

Electronic components are often subjected to a wash procedure in which a washing liquid such as water passes over and under the electronic components after they are mounted to a substrate. To meet certain standards and validate washing procedures, it is desirable to determine shear forces generated by the washing liquid. Conventional shear force measuring techniques only determine a shear force over or near the electronic components and not underneath the electronic components (between the electronic components and the substrate), thus leaving an incomplete synopsis of the effect of the washing liquid on the electronic components.

### SUMMARY

Embodiments of the present invention solve the above-mentioned problems and other problems and provide a distinct advance in the art of wash procedure validation. Embodiments of the invention are directed to a practical component, which is a “dummy” device that mimics the structure of actual electronic components for determining certain characteristics or behaviors of the electronic components or corresponding electronic assemblies. Practical components may be used to create or validate new manufacturing processes. Practical components can also be used to validate test procedures such as stress tests and wash procedures. This eliminates the need for manufacturing and handling actual electronic components for these purposes.

An embodiment of the invention is a practical component configured to be connected to a substrate for wash procedure validation via a liquid. The practical component includes a body, a movable section, and a sensor. The body includes a bridge and a number of supports extending from the bridge such that the body forms a spaced under the bridge. The supports are configured to be secured to the substrate to retain the bridge in a fixed position relative to the substrate. The movable section is at least partially positioned in the space and configured to shift relative to the body from the liquid passing through the space. The sensor is configured to detect movement of the movable section relative to the body for determining a shear force of the liquid against the movable section according to the relative movement.

Another embodiment is a method of validating a wash procedure. The method includes a step of attaching a practical component to a substrate so as to retain a bridge of the practical component in a fixed position relative to the substrate and form a space between the bridge and the substrate. The method further includes a step of passing a liquid through the space such that the liquid moves a movable section of the practical component positioned in the space. The method further includes a step of generating a signal representative of movement of the movable section relative to the bridge. The method further includes a step of determining a shear force according to the relative movement.

Another embodiment is a practical component configured to be connected to a substrate for wash procedure validation via a liquid. The practical component includes a body, a movable section, a first sensor, first geometry, a second sensor, and second geometry. The body includes a bridge and a number of supports extending from the bridge such that the body forms a space under the bridge. The supports are configured to be secured to the substrate to retain the bridge in a fixed position relative to the substrate. The movable section is at least partially positioned in the space and configured to shift relative to the body from the liquid passing through the space. The first sensor is configured to detect movement of the movable section relative to the body in a first axis or a first plane. The first geometry is configured to limit the first sensor to detecting the movement in the first axis or the first plane. The second sensor is configured to detect movement of the movable section relative to the body in a second axis or a second plane perpendicular to the first axis or the first plane. The second geometry is configured to limit the second sensor to detecting the movement in the second axis or the second plane for determining a shear force of the liquid against the movable section according to the relative movement in the first axis or the first plane and the second axis or the second plane.

### BRIEF DESCRIPTION OF THE DRAWING FIGURES

Embodiments of the present invention are described in detail below with reference to the attached drawing figures, wherein:

FIG. 1 is a side elevation cross section view of a practical component constructed in accordance with an embodiment of the present invention;

FIG. 2 is a side elevation cross section view of a practical component constructed in accordance with another embodiment of the present invention;

FIG. 3 is a side elevation cross section view of certain components of the practical component of FIG. 2; and

FIG. 4 is a flow diagram depicting certain steps of a method of validating a wash procedure in accordance with an embodiment of the invention.

The drawing figures do not limit the current invention to the specific embodiments disclosed and described herein. The drawings are not necessarily to scale, emphasis instead being placed upon clearly illustrating the principles of the invention.

### DETAILED DESCRIPTION

Practical components are “dummy” devices that mimic the structure of actual electronic components for determining certain characteristics or behaviors of the electronic components or corresponding electronic assemblies. Practical components may be used to create or validate new manufacturing processes. Practical components can also be used to validate test procedures such as stress tests and wash procedures. This eliminates the need for manufacturing and handling actual electronic components for these purposes.

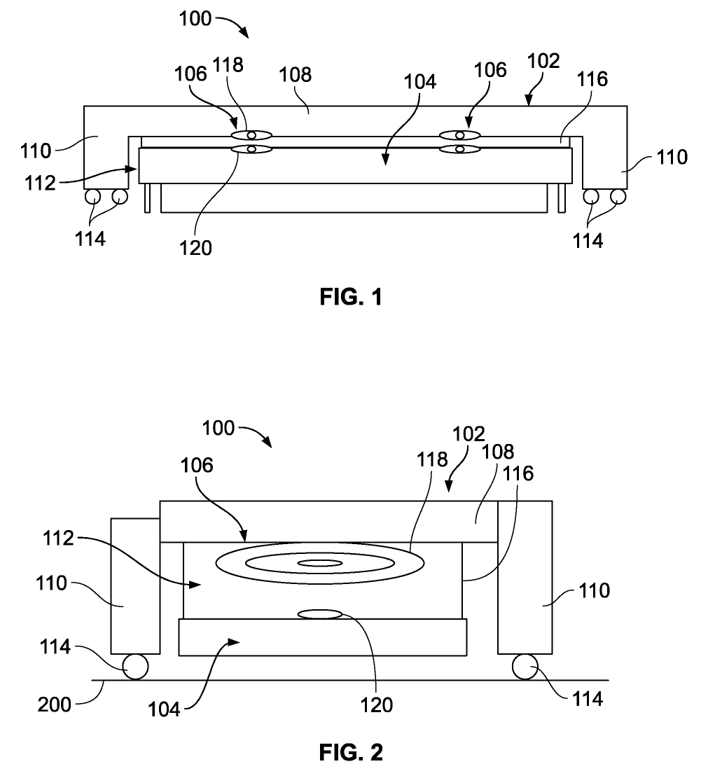

Turning to FIG. 1, a practical component 100 constructed in accordance with an embodiment of the invention will now be described. The practical component 100 may be configured to be removably or permanently secured to a substrate 200 (see FIG. 2) such as a printed circuit board (PCB) for measuring a shear force under the practical component 100 during a pressurized wash procedure. The practical component 100 broadly comprises a body 102, a movable section 104, and a sensor 106.

The body 102 may be similar to or mimic an electronic component and may include a bridge 108 and a plurality of supports 110. For example, the body 102 may have a shape similar to a particular chip or switch intended to be used in a circuit design. The body 102 may be fixedly secured to the substrate 200 so that the body 102 does not measurably move relative to the substrate 200.

The bridge 108 may extend between the plurality of supports 110 such that the body 102 forms a space 112 between the bridge 108 and the substrate 200. The bridge 108 may include traces, leads, vias, or the like for electronically connecting the sensor 106 to a processor. The bridge 108 may support the movable section 104 and certain sub-components of the sensor 106.

The plurality of supports 110 extend from the bridge 108 so that the bridge 108 is spaced from the substrate 200 when the body 102 is attached to the substrate 200. The plurality of supports 110 may be configured to be connected to specific points on the substrate 200. For example, the plurality of supports 110 may be configured to be soldered to metal pads on the substrate 200 or may include leads 114 configured to be soldered to metal pads on the substrate 200. In such cases, the plurality of supports 110 and/or leads 114 may have an arrangement similar to an arrangement of supports or leads of an electronic component which the practical component mimics. To that end, the leads 114 may be structurally equivalent to leads of an electronic component but not intended to provide any electronic function. On the other hand, the leads 114 may be electronically connected to the sensor 106 for transmitting signals therefrom to a processor via traces on the substrate 200. Preferably, the leads 114 (if present) are only for attaching the practical component 100 to the substrate 200, and hence sensor signals are transmitted elsewhere. The leads may be ball grid array (BGA), quad flat no-lead (QFN), or any other suitable type of leads.

The movable section 104 may be a fin, a vane, or the like suspended from the bridge 108 via a shear material 116 or shear structure. The movable section 104 may be configured to move relative to the body 102, and specifically the bridge 108, when subjected to a shear force by a liquid passing through the space 112 during a washing procedure. The movable section 104 may be shaped, positioned, or attached to the bridge 108 so that the movable section 104 can only move in one direction (i.e., along one axis or plane) so that the sensor 106 only detects a shear force in that direction. An additional section may be shaped, positioned, or attached to the bridge 108, with a corresponding additional sensor, for detecting shear force in an additional direction that is not the same direction as the aforementioned direction. In this way, the same type of sensor, or even omnidirectional sensors, may be used to obtain specific-direction readings (e.g., X shear and Y shear). The moveable section 104 may also be configured to move in more than one direction, particularly suitable for an optical sensor as described below.

The shear material 116 may be a polymer, elastomer, silicone, or the like. The shear material 116 may also or alternatively be a spring, flexible sheet, or similar structure.

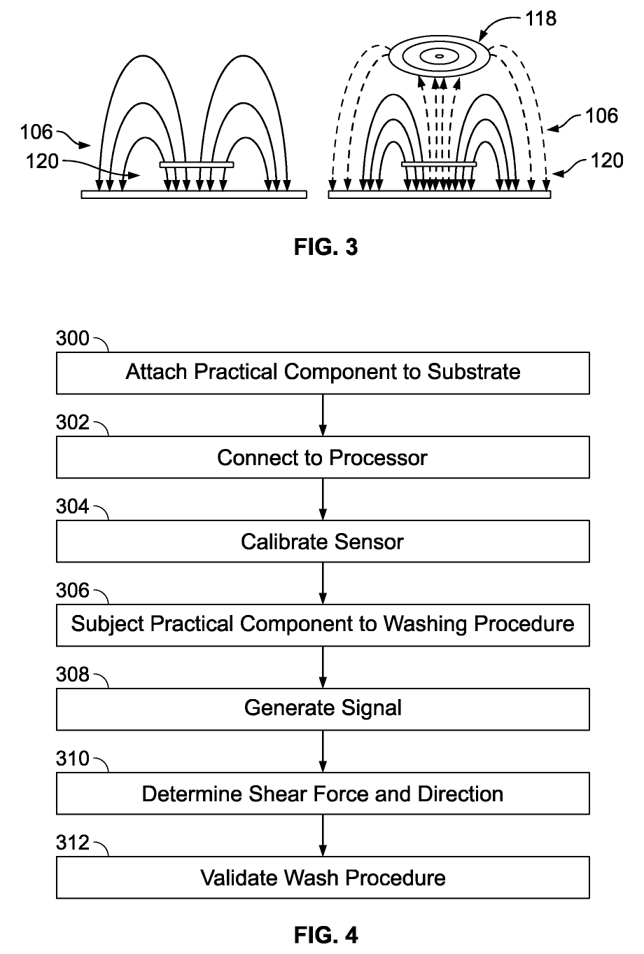

The sensor 106 may be configured to detect movement of the movable section and hence a shear force on the movable section 104. To that end, the sensor 106 may include a first subcomponent 118 attached to the bridge 108 and a second subcomponent 120 attached to the movable section 104. Movement of the second subcomponent 120 relative to the first subcomponent 118 may induce a change in magnetic field, electrical resistance, electrical induction, electrical capacitance, electrical current, or the like. To that end, the sensor 106 may be a magnetometer, a Hall Effect sensor, a capacitive sensor, or the like. In the case of a capacitance sensor, the first subcomponent 118 may be a target and the second subcomponent may be a capacitor including capacitor plates, as shown in FIGS. 2 and 3. In that case, movement of the target relative to the capacitor plates increases or decreases capacitance of the capacitor. In yet another embodiment, the movable section 104 and sensor 106 could act as a strain gauge with a metal flex film. The sensor 106 may be configured to transmit signals to an offboard processor, microcontroller, or the like, optionally in a watertight enclosure. Furthermore, the sensor 106 may act as a pass/fail sensor.

In another embodiment, relative movement between subcomponents may induce an optical change. To that end, the sensor 106 may be an optical sensor as shown in FIG. 1. In the case of an optical sensor, the first subcomponent 118 and/or second subcomponent 120 may be photon eyes. Relative movement between the photon eyes may increase or decrease an output of the optical sensor.

In yet another embodiment, the sensor 106 may be configured to change appearance when subjected to a shear force. In one embodiment, the sensor 106 may be configured to change appearance (e.g., color change) only upon being subjected to a predetermined threshold shear force. In these cases, the sensor 106 may be an omnidirectional sensor, meaning the sensor 106 cannot discern a direction of the shear force. On the other hand, geometry/structure of the practical component 100 may cause the sensor 106 to be subjected to a shear force in only one direction (axis, or plane), thus effectively providing a directional sensor. An additional sensor constrained by similar geometry/structure of the practical component 100 but oriented at an angle (e.g., 90 degrees—i.e., perpendicular) relative to the sensor 106 thus allows for additional directional sensing (e.g., X shear and Y shear).

Turning to FIG. 4, a method of using the practical component 100 will now be described in detail. First, the practical component 100 may be attached to the substrate 200 to mimic attachment of a working electronic component, as shown in block 300. To that end, leads 114 or supports 110 may be connected to the substrate 200 via soldering, welding, fusion, or fasteners.

The practical component 100 may also be communicatively connected to a processor for recording or analyzing signals from the sensor 106, whether via the leads 114 and traces of the substrate 200, via separate circuitry, or via a wireless communication connection, as shown in block 302.

The sensor 106 may then be calibrated, as shown in block 304. For example, the sensor 106 may generate and transmit a signal representative of a baseline or zeroed shear value. The sensor 106 may do this automatically or may be prompted, interrogated, or activated.

The substrate and practical component 100 may then be subjected to a washing procedure whereby a washing liquid, such as water, is passed over and underneath the practical component 100, as shown in block 306. The washing liquid may exert a shear force on the movable section 104, which in turn moves at least the second subcomponent 120 of the sensor 106 relative to the first subcomponent 118.

The sensor 106 may then generate a signal representative of movement of the movable section 104 relative to the bridge 108, as shown in block 308. This may include generating a new signal, or the signal generated by the sensor 106 before the movement is induced may be augmented according to the relative movement. For example, a characteristic or value of the signal may increase, decrease, or change based on the relative movement such that the signal represents relative movement and hence a shear force and/or shear direction of the washing liquid acting on the movable section. As mentioned previously, additional shear sensors may generate and transmit additional signals, thus providing additional shear force values.

A shear force and direction may then be determined according to the relative movement, or a more comprehensive dataset of shear forces and directions may be determined, as shown in block 310. The latter may be useful where fluid flow is non-uniform. Regions of high shear concentration may be identified for modifying chip design accordingly. Alternatively, it may be desired to only identify a simple high shear value, in which case an omnidirectional sensor may be sufficient.

The wash procedure may then be validated if the shear force (or forces) is below a predetermined threshold, as shown in block 312. The wash procedure may be rejected or modified if the shear force (or force) is at or above the predetermined threshold.

The above-described invention provides several advantages. For example, the practical component 100 provides a shear force magnitude and/or direction of washing liquid beneath an electronic component. The practical component 100 may have one of a number of sizes and shapes (including various packages or footprints) for mimicking various electronic components. The practical component 100 can be placed on a substrate without the need for a full circuit design or production beforehand. The practical component 100 may be placed on test assemblies. Various sensing types such as optical, Hall Effect, or capacitive sensing can be used. The practical component thus facilitates validation of cleaning processes to be used in production of a circuit or component. The practical component 100 may provide more comprehensive data, which may help meet higher production requirements and “process prove-in” of cleaning equipment.

In another embodiment, the practical component 100 does not include movable section 104. The sensor 106 may be positioned in, or in sensing relation with, space 112. The sensor 106 may be configured to sense movement in the space 112. For example, the sensor 106 may be configured to sense movement of the liquid passing through the space 112 during the wash procedure. This may include sensing movement at various points in the space 112 such that a flow profile or flow model may be created. The wash procedure may then be validated based on acceptability of flow of the liquid at the various points in the space 112. A shape of the bridge 108, a height of the plurality of supports 110 (and hence height or size of the space 112), or other parameters may be changed to improve flow of the liquid.

### Additional Considerations

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises”, “comprising”, “includes”, “including”, “has”, “having”, or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

1. A practical component configured to be connected to a substrate for validation of a wash procedure via a liquid, the practical component comprising:
a body including:
a bridge; and
a plurality of supports extending from the bridge such that the body forms a space under the bridge, the supports being configured to be secured to the substrate to retain the bridge in a fixed position relative to the substrate; and
a sensor configured to detect movement relative to the body in the space under the bridge for determining a quality associated with the wash procedure.

2. The practical component of claim 1, wherein the sensor is configured to detect movement of the liquid in the space under the bridge.

3. The practical component of claim 1, wherein the sensor is an electronic sensor.

4. The practical component of claim 1, further comprising a movable section at least partially positioned in the space and configured to shift relative to the body from the liquid passing through the space, the sensor being configured to detect movement of the movable section relative to the body for determining a shear force of the liquid against the movable section according to the relative movement.

5. The practical component of claim 4, wherein the sensor is an optical photon sensor including a photon eye positioned on at least one of the bridge and the movable section.

5. The practical component of claim 4, wherein the sensor is a capacitive sensor including a capacitor and a target, wherein the target increases capacitance when aligned with the capacitor so that movement of the movable section changes capacitance of the sensor.

6. The practical component of claim 4, wherein the sensor is at least one of a magnetometer and a Hall Effect sensor.

7. The practical component of claim 4, wherein the sensor is configured to change appearance upon being subjected to the shear force.

8. The practical component of claim 4, wherein the sensor is configured to detect the movement in a single axis or plane.

9. The practical component of claim 4, wherein the sensor is configured to detect the movement in a first axis or plane, and wherein the practical component further comprises an additional sensor configured to detect the movement in a second axis or plane different from the first axis or plane.

10. The practical component of claim 4, wherein the practical component includes geometry configured to focus the sensor to detecting the movement in a single axis or plane.

11. The practical component of claim 4, the sensor being a first sensor, the practical component further comprising a second sensor, wherein the practical component includes first geometry configured to limit the first sensor to detecting the movement in a first axis or a first plane, and second geometry configured to limit the second sensor to detecting the movement in a second axis or a second plane different from the first axis or the first plane.

12. The practical component of claim 4, wherein the sensor is an omnidirectional sensor.

13. A method of validating a wash procedure, the method comprising steps of:
attaching a practical component to a substrate so as to retain a bridge of the practical component in a fixed position relative to the substrate and form a space between the bridge and the substrate;
passing a liquid through the space such that the liquid moves a movable section of the practical component positioned in the space;
generating a signal representative of movement of the movable section relative to the bridge; and
determining a shear force according to the relative movement.

14. The method of claim 13 wherein the signal is based on optical detection via a photon sensor.

15. The method of claim 13, wherein the signal is based on capacitance detection via a capacitance sensor.

16. The method of claim 13, wherein the signal is based on magnetic detection via at least one of a magnetometer and a Hall effect sensor.

17. The method of claim 13, wherein the signal is representative of relative movement between the movable section and the bridge in a single axis or plane.

18. The method of claim 13, wherein the signal is agnostic as to direction of relative movement between the movable section and the bridge.

19. The method of claim 13, wherein the signal is a first signal representative of relative movement between the movable section and the bridge in a first axis or a first plane, the method further comprising a step of generating a second signal representative of relative movement between the movable section and the bridge in a second axis or a second plane different from the first axis or the first plane.

20. A practical component configured to be connected to a substrate for wash procedure validation via a liquid, the practical component comprising:
a body including:
a bridge; and
a plurality of supports extending from the bridge such that the body forms a space under the bridge, the supports being configured to be secured to the substrate to retain the bridge in a fixed position relative to the substrate;
a movable section at least partially positioned in the space and configured to shift relative to the body from the liquid passing through the space;
a first sensor configured to detect movement of the movable section relative to the body in a first axis or a first plane;
first geometry configured to focus the first sensor to detecting the movement in the first axis or the first plane;
a second sensor configured to detect movement of the movable section relative to the body in a second axis or a second plane perpendicular to the first axis or the first plane; and
second geometry configured to focus the second sensor to detecting the movement in the second axis or the second plane for determining a shear force of the liquid against the movable section according to the relative movement in the first axis or the first plane and the second axis or the second plane.
